(19) United States
(12) Patent Application Publication
(10) Pub. No.: US 2007/0226197 A1
(43) Pub. Date: Sep. 27, 2007

(54) Database system, computer program and advertisement presentation method in database system

(75) Inventors: Youichi Kawakami, Osaka (JP); Kosuke Sasai, Kobe-shi (JP)

Correspondence Address: BRINKS HOFER GILSON & LIONE, P.O. BOX 10395, CHICAGO, IL, 60610, US

(73) Assignee: Konica Minolta Medical & Graphic, Inc.,

(21) Appl. No.: 11/725,638

(22) Filed: Mar. 20, 2007

(30) Foreign Application Priority Data
Mar. 27, 2006 (JP) JP2006-085274

(51) Int. Cl. G06F 17/30

(52) U.S. Cl. 707/3

(57) ABSTRACT

A database system comprising: a database storing a plurality of types of information; a storage storing element associated information in which a plurality of elements included in said plurality of types of information are associated with each other and element-advertisement associated information in which advertising information is associated with a combination of two or more elements included in the plurality of elements; and a presentation device visibly presenting the advertising information by referring to the element-advertisement associated information when information entered by a user corresponds to the combination of two or more elements.

This application is based on application No. 2006-85274 filed in Japan, the contents of which are hereby incorporated by reference.

### BACKGROUND OF THE INVENTION

1. Field of the Invention

The present invention relates to a database system.

2. Description of the Background Art

In conventional search/retrieval systems over the Internet or the like, techniques for presenting various advertisements on a screen showing search results have been brought into practical use, and systems to charge advertisers for their advertisements already exist.

Such systems have generally employed techniques for previously registering advertisements in association with keywords and displaying advertisements in accordance with an entered keyword. Besides, a technique for setting keywords in association with advertisements and inserting advertisements in the contents containing a set keyword (e.g., Japanese Patent Laid-Open No. 2001-256312).

The techniques for setting advertisements in association with keywords, however, require an advertiser to register advertisements for all keywords that could be possibly thought of, which makes the registration operation complicated and difficult and further makes it difficult to distribute advertisements only to users to whom the advertiser actually wants to distribute. Furthermore, a problem arises in that advertisements are not narrowed down while information that a user needs is sequentially narrowed down as the searching operation progresses. These problems are also encountered in the technique presented by the aforementioned JP2001-256312.

### SUMMARY OF THE INVENTION

The present invention is directed to a database system.

According to the invention, the database system comprises: a database storing a plurality of types of information; a storage storing element associated information in which a plurality of elements included in the plurality of types of information are associated with each other and element-advertisement associated information in which advertising information is associated with a combination of two or more elements included in the plurality of elements; and a presentation device visibly presenting the advertising information by referring to the element-advertisement associated information when information entered by a user corresponds to the combination of two or more elements.

This allows presentation of appropriate advertisements in accordance with user's conditions.

The present invention is also directed to a computer program controlling a computer to operate as a database system.

The present invention is further directed to an advertisement presentation method.

It is therefore an object of the present invention to provide a technique capable of presenting appropriate advertisements in accordance with users' conditions.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically illustrating the structure of a DB system according to a preferred embodiment of the present invention;

FIG. 2 is a diagram illustrating the flow of information in the DB system;

FIG. 3 is a block diagram illustrating the functional structure of the DB system;

FIG. 4 is a functional block diagram illustrating search-related operations;

FIG. 5 is a diagram illustrating the structuration of elements of information provided;

FIG. 6 is a diagram illustrating element associated information;

FIG. 7 is a diagram illustrating element-advertisement associated information;

FIG. 8 is a diagram illustrating an initial search screen;

FIG. 9 is a diagram illustrating a search result screen;

FIG. 10 is a diagram illustrating a detailed advertising screen;

FIG. 11 is a diagram illustrating the contents of advertisement-access control table information;

FIG. 12 is a diagram illustrating the contents of charging list information;

FIGS. 13 and 14 are diagrams each schematically showing an operational flow of the DB system;

FIG. 15 is a diagram illustrating element associated information in an e-learning system;

FIG. 16 is a diagram illustrating element-advertisement associated information in the e-learning system;

FIG. 17 is a diagram illustrating the hierarchical structure of contents in an auction site;

FIG. 18 is a diagram illustrating element associated information in an auction system;

FIG. 19 is a diagram illustrating element-advertisement associated information in the auction system;

FIG. 20 is a diagram illustrating the hierarchical structure of contents in a real estate search/retrieval site;

FIG. 21 is a diagram illustrating element-advertisement associated information in a real estate search/retrieval system;

FIG. 22 is a diagram illustrating the hierarchical structure in a search/retrieval site for personal computer purchase; and

FIG. 23 is a diagram illustrating element-advertisement associated information in a search/retrieval system for personal computer purchase.

### DESCRIPTION OF THE PREFERRED EMBODIMENTS

Hereinafter, a preferred embodiment of the present invention will be described with reference to the accompanied drawings.

### General Structure of Database System

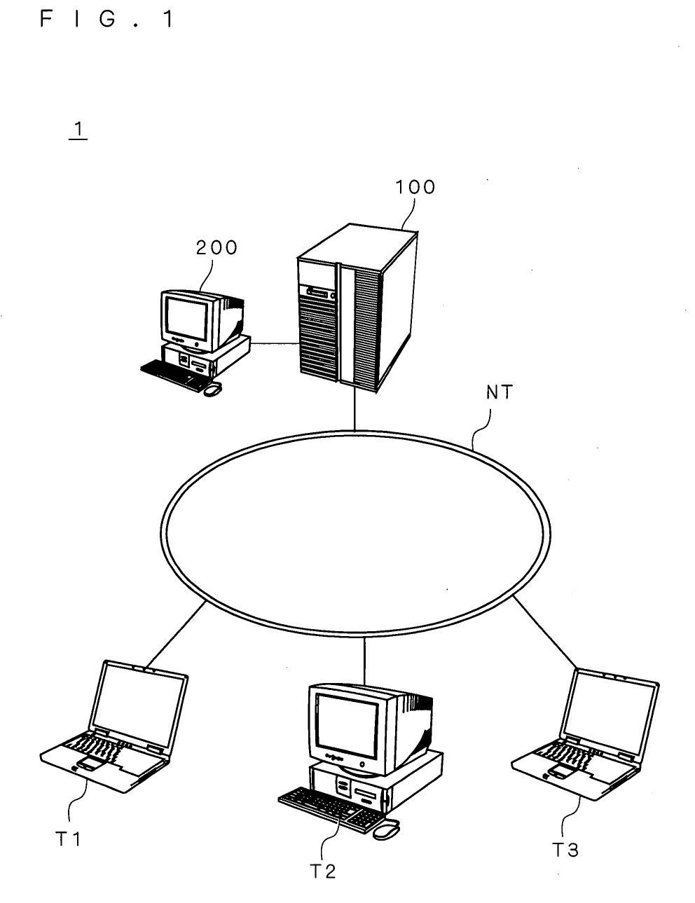

FIG. 1 is a diagram schematically illustrating the structure of a database (DB) system 1 according to a preferred embodiment of the present invention. Here, the DB system 1 is structured as, for example, a medical information DB system of storing information relating to medical care (medical information) and extracting and presenting the name of disease being suspected and the like in response to an entered query indicating symptoms and the like.

In the DB system 1, a search server 100 and user terminals T1 to T3 are connected via a communications circuit NT, such as the Internet line, such that mutual data transmission can be made. The communications circuit NT is not limited to the Internet line, but various communication lines including LAN may be employed.

The search function is implemented in the DB system 1 as a Web application, and query transmission from the user terminals T1 to T3 to the search server 100 and transmission of information indicative of search results (search result information) from the search server 100 to the user terminals T1 to T3 are carried out by using a browser. The search function is not limited to the one that is implemented as a Web application, but, for example, a dedicated client software may be provided instead of a browser.

The search server 100 is managed by inputs from a management terminal 200.

### General Flow of Information in DB System

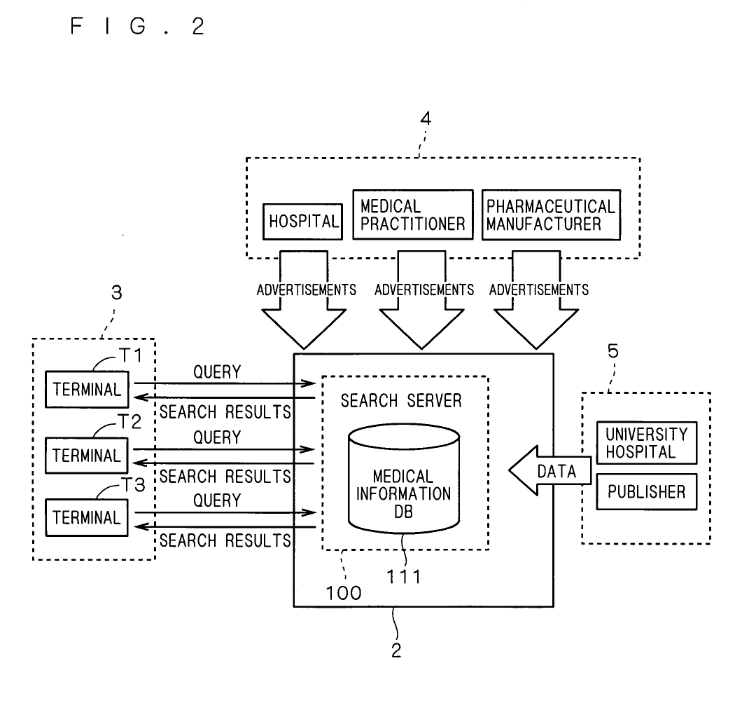

FIG. 2 is a diagram schematically illustrating the flow of information in the DB system 1.

The search server 100 has a database (medical information DB) 111 storing a large number of medical information to be searched through. This search server 100 is installed, for example, in a data center 2 which runs the DB system 1, and is managed/operated in accordance with inputs from a terminal for management, and the like.

An advertiser 4 makes a request of the data center 2 for advertisement registration into the search function implemented in the DB system 1. The advertiser 4 pays a fee (advertising fee) in accordance with effects exerted by his/her advertisements. The advertising fee may be determined by a predetermined rule at the time when advertisement registration is requested.

For instance, when a user 3 of the DB system 1 enters a query from the user terminal T1, the search server 100 acquires search result information corresponding to the query and transmits the search result information to the user terminal T1, so that the search result information is visibly output on the user terminal T1. At the same time, advertisements whose registration have been requested by the advertiser 4 are displayed on the user terminal T1 together with the search results on the basis of a predetermined rule.

For instance, the search function of the DB system 1 is available for users free of charge through user terminals having an environment that is accessible to a network including the search server 100.

An information provider 5 provides various types of information (knowledge) to be stored in the medical information DB 111 of the search server 100. This information provider 5 may be a hospital storing many cases such as a university hospital, a publisher, or the like. The data center 2 makes remuneration to the information provider 5 for provided information. In the case where the information provider 5 is also the advertiser 4, the advertising fee may be reduced/exempted.

### Functional Structure of DB System

FIG. 3 is a block diagram illustrating the functional structure of the DB system 1. In the case illustrated in FIG. 3 by way of example, a user (searcher) of the DB system 1 enters a query from the user terminal T1 for conducting a search, and information to be added to the medical information DB 111 is provided by an information provider from the user terminal T2. The user terminal T3 has the same configuration as that of the user terminals T1 and T2, and illustration in FIG. 3 and explanation herein will be omitted. Practically, a searcher may enter a query from any of the user terminals T1 to T3, and an information provider may use any of the user terminals T1 to T3.

### User Terminal T1

The user terminal T1 is, for example, a personal computer used in an ordinary home. The user terminal T1 may be a personal digital assistant (PDA) or the like. This user terminal T1 mainly includes a terminal control unit 210, a storage unit 220, a display unit 230, an operation unit 240 and an interface (I/F) 250.

The I/F 250 is an interface for controlling data transmission via the communications circuit NT to/from the search server 100 and the like.

The storage unit 220 is formed of, for example, a hard disc and the like, and stores a program PG1 for implementing some of functions of the DB system 1. In the user terminal T1, the terminal control unit 210 reads and executes the program PG1, to thereby implement the functions of the DB system 1.

The operation unit 240 includes, for example, a keyboard, a mouse and the like, and, when operated as appropriate by a user (searcher) of the user terminal T1, the operation unit 240 transmits a various types of signals to the terminal control unit 210 in response to the operation.

The display unit 230 is formed of, for example, a CRT or a liquid crystal panel, and visibly outputs various types of images in response to a signal from the terminal control unit 210.

The terminal control unit 210 includes a CPU 211 and a memory 212, and implements various functions and operations on the basis of various types of signals from the operation unit 240, program PG1 stored in the storage unit 220 and the like. Various types of data generated in the course of information processing in the terminal control unit 210 are stored temporarily in the memory 212.

When a user (searcher) enters a query for search by operating the operation unit 240 as appropriate, search result information and advertising information extracted in the search server 100 are visibly output on the display unit 230.

### User Terminal T2

The user terminal T2 is formed of, for example, a personal computer, similarly to the user terminal T1. The user terminal T2 mainly includes a terminal control unit 310, a storage unit 320, a display unit 330, an operation unit 340 and an interface (I/F) 350. These components have similar functions to the terminal control unit 210, storage unit 220, display unit 230, operation unit 240 and interface (I/F) 250 of the user terminal T1, respectively, and redundant explanations will thus be omitted. The terminal control unit 310 of the user terminal T2 reads and executes a program PG2 stored in the storage unit 320, to thereby implement various functions.

Herein, a user (information provider) is capable of providing various types of information for the search server 100 by operating the operation unit 340 as appropriate.

### Management Terminal 200

A management terminal 200 is formed of, for example, a personal computer, similarly to the user terminals T1 and T2. The management terminal 200 mainly includes a terminal control unit 410, a storage unit 420, a display unit 430, an operation unit 440 and an interface (I/F) 450. These components have similar functions to the terminal control unit 210, storage unit 220, display unit 230, operation unit 240 and interface (I/F) 250 of the user terminal T1, respectively, and redundant explanations will thus be omitted. The terminal control unit 410 of the management terminal 200 reads and executes a program PG3 stored in the storage unit 420, to thereby implement various functions.

Herein, an administrator of the DB system 1 operates the operation unit 440 as appropriate to enter various types of management information into the search server 100. Further, information indicative of advertising fees (charging information) and information indicative of rewards to information providers (reward information) can be read out from the search server 100 by the management terminal 200.

### Search Server 100

The search server 100 mainly includes a storage unit 110, a control unit 120 and an I/F 130.

The I/F 130 is an interface for controlling data transmission via the communications circuit NT to/from the user terminals T1, T2 and the like, and data transmission to/from the management terminal 200.

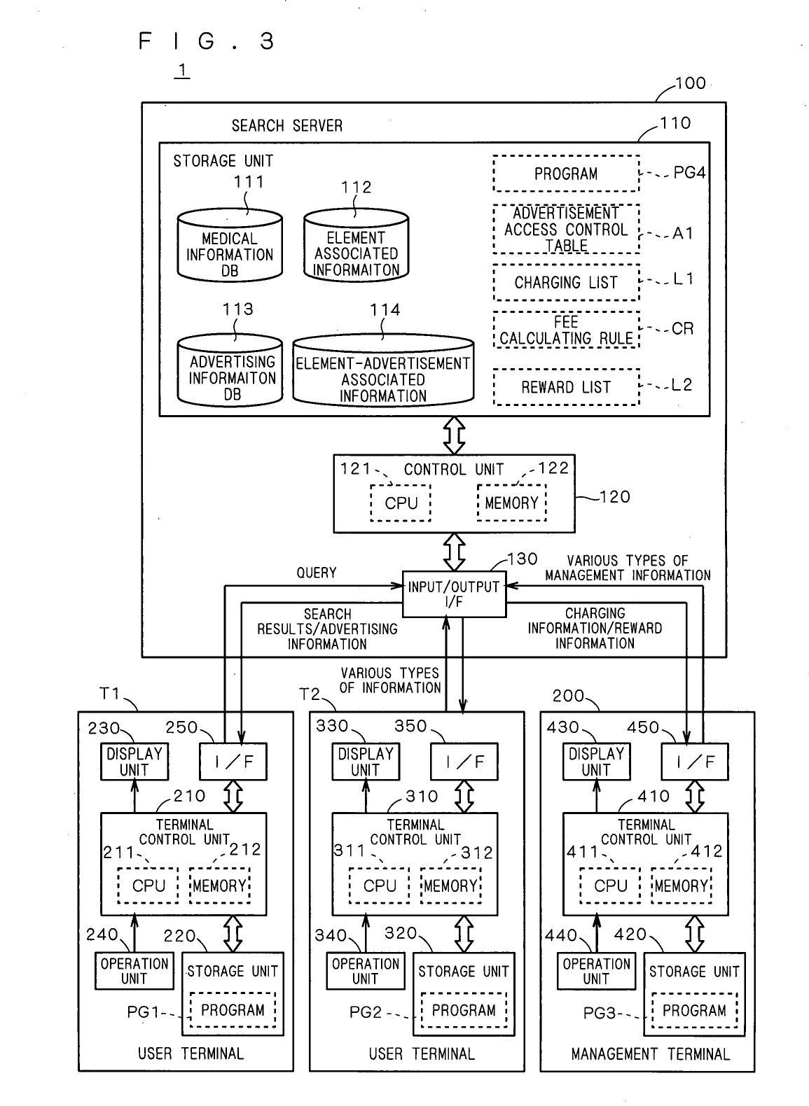

The storage unit 110 is formed of, for example, a hard disc and the like, and stores a program PG4 for implementing the functions of the search server 100. In the search server 100, the control unit 120 reads and executes the program PG4, to thereby implement the functional structure shown in FIG. 4, and the like.

The storage unit 110 stores medical information DB 111, element associated information 112, advertising information DB 113, element-advertisement associated information 114, advertisement access control table A1, charging list information L1, fee calculating rule information CR and reward list information L2.

The medical information DB 111 stores a plurality of pieces of medical information such as data on findings in many electronic medical records. These plurality of pieces of medical information are provided from the user terminal T2, for example.

The element associated information 112 indicates association between a plurality of elements (e.g., words, phrases, etc.) included in the plurality of pieces of medical information stored in the medical information DB 111, and described in the Resource Description Framework (RDF) format or the like. The element associated information 112 is generated on the basis of the plurality of pieces of medical information stored in the medical information DB 111.

The advertising information DB 113 stores many candidates for advertising information to be visibly output on the display unit 230 of the user terminal T1 together with search result information. A plurality of pieces of advertising information stored in the advertising information DB 113 are entered from the management terminal 200 on the basis of requests from advertisers, for example.

The element-advertisement associated information 114 is information indicative of association between the plurality of elements included in the element associated information 112 and the plurality of pieces of advertising information stored in the advertising information DB 113. The control unit 120 determines advertising information to be output to the user terminal T1 together with search result information, by referring to the element-advertisement associated information 114. The element-advertisement associated information 114 is entered from the management terminal 200 on the basis of requests from advertisers, for example.

The advertisement access control table A1 is intended to manage the access conditions of users (searchers) making access to advertising information.

The charging list information L1 is information indicative of a list for managing advertising fees determined in accordance with advertising effectiveness upon users (searchers).

The fee calculating rule information CR is information indicative of rules for calculating advertising fees on the basis of advertising effectiveness upon users (searchers).

The reward list information L2 is information indicative of a list for managing the details of rewards for information provided by information providers.

The control unit 120 includes a CPU 121 and a memory 122, and controls operations relating to the DB system 1 on the basis of various signals from the management terminal 200 and user terminals T1 to T3, program PG4 and the like. Herein, the control unit 120 reads and executes the program PG4 stored in the storage unit 110 on the basis of, for example, a signal from the management terminal 200, so that functions and operations of the DB system 1 are implemented. Various types of data generated in the course of information processing in the control unit 120 are stored temporarily in the memory 122.

In the DB system 1, respective functions such as the control unit 120, terminal control units 210, 310, 410 and the like cooperate with each other to make transmission of various types of data to/from the search server 100, thereby implementing an operation of structuring information for use in the search through medical information (hereinafter referred to as a “search information structuring operation”) and an operation relating to the medical information search (hereinafter referred to as a “medical information search operation”). Hereinafter, operations relating to a search including the search information structuring operation and medical information search operation will be referred to as “search-related operations”.

The search-related operations in the DB system 1 will now be described.

### Search-Related Operations

FIG. 4 is a diagram illustrating the functions achieved in the control unit 120 in executing the search-related operations. In executing the search-related operations, the control unit 120 is configured to have, as its functions, a machine learning part 21, a data construction part 22, an element-advertisement associating part 23, a data retrieving part 24, an element-combination identifying part 25, an advertising-information extracting part 26, a data transmitting part 27, an access-condition identifying part 28, an advertising-fee calculating part 29, a reward-information determining part 30 and a calculating-rule changing part 31.

### Machine Learning Part 21

The machine learning part 21 learns reference information for structuration of a plurality of pieces of medical information stored in the medical information DB 111 by being supplied with a learning corpus as teaching data, for example.

The learning corpus includes large amounts of text data conforming to the format (text model) of sentences of findings in the electronic medical record. This text model represents the structure of sentences of findings in the electronic medical record, such as symptom, name of disease, medicine and treatment in this order, for example. In the learning corpus, classified item names of elements forming the text model of sentences of the findings included in a model of the electronic medical record (also called an “electronic medical record model”) are tagged to words and phrases.

Examples of the element classified items include a “symptom”, a “name of disease”, a “medicine”, a “treatment”, and the like. In the teaching data, words such as “headache”, “dizziness”, “fever”, “nausea”, etc. are listed in correspondence with the element classified item “symptom”, words such as “appendicitis”, “influenza”, etc. are listed in correspondence with the element classified item “name of disease”, phrases such as “medicine 1”, “medicine 2”, etc. are listed in correspondence with the element classified item “medicine”, and words such as “injection”, “nutrition”, etc. are listed in correspondence with the element classified item “treatment”.

And in the learning corpus, for example, the element classified item name “category” is tagged to each of words such as “headache”, “dizziness”, “fever”, “nausea”, and the like. The element classified item name “name of disease” is tagged to each of words such as “appendicitis”, “influenza”, and the like. The element classified item name “medicine” is tagged to each of phrases such as “medicine 1”, “medicine 2”, and the like. The element classified item name “treatment” is tagged to each of words such as “injection”, “nutrition”, and the like.

The machine learning part 21 extracts words and phrases from the learning corpus, and stores them under their corresponding element classified items, respectively. Namely, the machine learning part 21 learns and stores a word and/or phrase belonging to each element classified item under each element classified item, by using the teaching data including the learning corpus as learning materials and referring to the teaching data. At this time, the machine learning part 21 normalizes variations of words, phrases and expressions to a degree.

The machine learning part 21 also learns and stores appearance patterns of the elements in the learning corpus. For example, the machine learning part 21 learns and stores an appearance pattern where the symptom “fever” is followed by a word or phrase belonging to the “name of disease”, i.e. an appearance pattern indicative of what kinds of words or phrases belonging to what kinds of classified items appear in what order.

The data learned by and stored in the machine learning part 21 is used as data of a model (model data) indicative of the types of element classified items into which elements forming a plurality of findings stored in the medical information DB 111 are decomposed. The model data may previously be obtained from the outside.

### Data Construction Part 22

The data construction part 22 has the function of identifying the element classified items and the actually used words or phrases in information on a plurality of findings stored in the medical information DB 111, by referring to the model data learned in the machine learning part 21.

The data construction part 22 decomposes the findings into words and/or phrases (elements) under the element classified items and describes the elements in RDF based on the information where the element classified items are identified, thereby structuring the findings. Further, the data construction part 22 adds patient attributes to the structured findings, thereby generating structured data described in RDF.

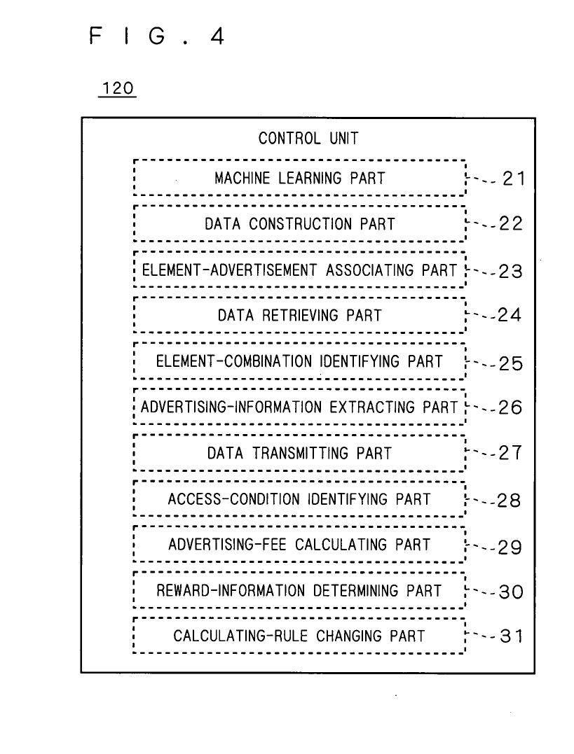

FIG. 5 illustrates data (hereinafter also referred to as “single-finding structured data”) obtained by structuring elements (which also include elements forming attribute information) of findings of one electronic medical record. As shown in FIG. 5, for a file “A-0001” of electronic medical records, attribute values “fever”, “influenza”, “medicine 1” and “injection” are associated with the element classified items “symptom”, “name of disease”, “medicine” and “treatment” as attribute items, respectively, and described in RDF. Also, “Tokkyo Taro” is associated with an attribute item “patient” about attribute information. As to attributes of the patient, “M” and “53” are associated with attribute items “sex” and “age”, respectively.

Further, with respect to a large number of single-finding structured data, the data construction part 22 performs processing of arranging a plurality of elements (herein, attribute values) associated with a single file in each piece of single-finding structured data, under their corresponding attribute items, associating the elements again with each other and describing them in RDF. As a result of the processing, information (hereinafter also referred to as “network information”) is prepared in which a plurality of elements (which are words and phrases in this case) are listed for each attribute item included in a plurality of attribute items, with the elements being associated like a network between the attribute items.

That is, the data construction part 22 structures a plurality of elements included in a plurality of pieces of information stored in the medical information DB 111 and associating the elements with each other, by using various types of language processing, thereby generating network information. This network information is stored in the storage unit 110 as the element associated information 112.

FIG. 6 is a diagram illustrating the structuration of elements of a plurality of findings, by way of example. In FIG. 6, associated elements are illustrated as linked by lines.

While FIG. 6 shows the case in which the element belonging to the item “name of disease” has the element “influenza”, the name of disease may be expressed in findings by a narrower term such as “A/Hong Kong”, rather than a generic term such as “influenza”. In such case, the element associated information 112 may be structured by replacing a narrower term with a broader term.

### Element-Advertisement Associating Part 23

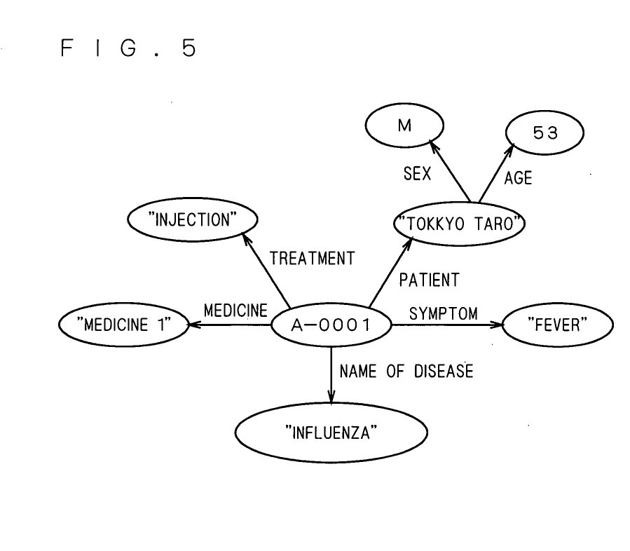

The element-advertisement associating part 23 generates element-advertisement associated information 114 on the basis of a signal input by an administrator operating the operation unit 440 of the management terminal 200 as appropriate, and stores it in the storage unit 110. This element-advertisement associated information 114 is information in which advertising information contained in the advertising information DB 113 is associated with a single element and/or a combination of two or more elements included in a plurality of elements constituting the element associated information 112, and FIG. 7 illustrates an example.

As shown FIG. 7, for example, in the element associated information 112, advertising information of “XXX medicine (pharmaceutical manufacturer A)” is associated with the combination of elements “fever” and “influenza”, advertising information of “vaccination (hospital B)” is associated with the element “influenza”, and advertising information of “Mr. so-and-so (medical practitioner C)” is associated with the combination of elements “medicine 2” and “nutrition”.

### Data Retrieving Part 24

The data retrieving part 24 runs a search in the storage unit 110 and extracts information corresponding to various types of information (queries, etc.) entered on the screen displayed on the display unit 230 of the user terminal T1. Information extracted by the data retrieving part 24 is stored temporarily in the memory 122.

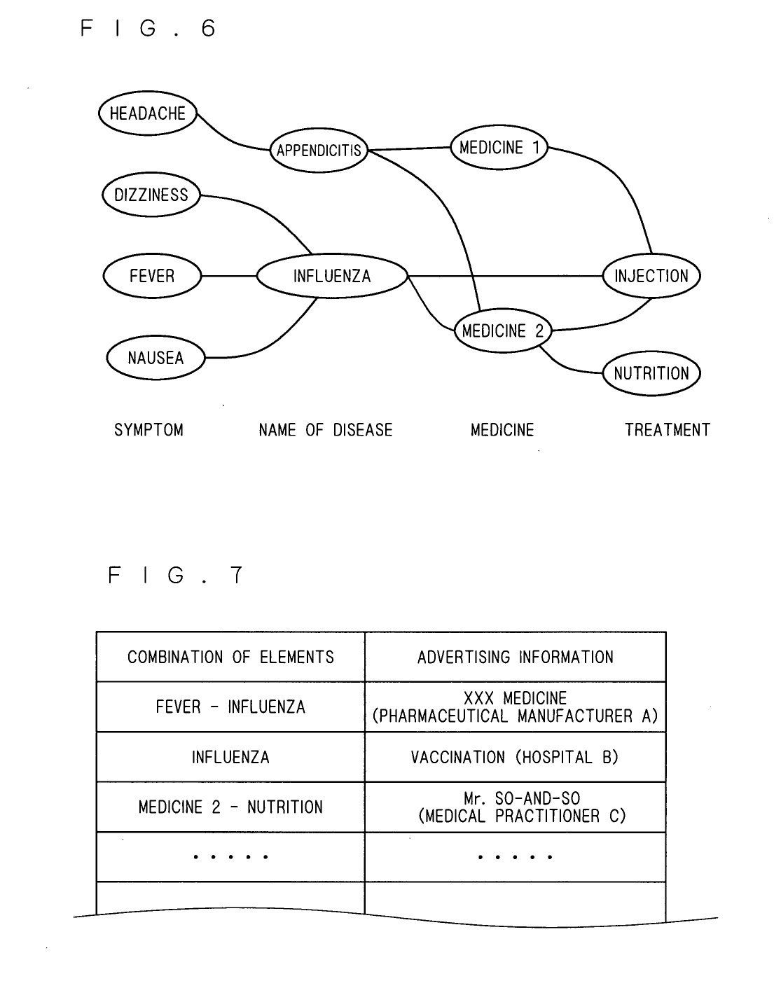

FIG. 8 is a diagram illustrating an example of an initial screen (initial search screen) G1 displayed on the display unit 230 when searching medical information in the user terminal T1. In the initial search screen G1, a box B1 for entering a symptom corresponding to a query for search, a box B2 for entering the body temperature and a box B3 for entering other symptoms are displayed. A searcher operates the operation unit 240 as appropriate to enter symptoms and the like to the boxes B1 to B3 in the initial search screen G1 as appropriate, and left-clicks placing the mouse pointer MP over the “next” button, to thereby instruct search execution. At this time, the data retrieving part 24 searches and extracts element information (herein, name-of-disease element information) indicative of the name of disease being suspected corresponding to a query entered in the initial search screen G1, and stores it temporarily in the memory 122 as search result information.

As the method of extracting search result information from entered information (e.g., information indicative of symptoms), extraction from the element associated information 112, or various general techniques may be employed.

### Element-Combination Identifying Part 25

The element-combination identifying part 25 identifies a single element and/or a combination of two or more elements included in the element associated information 112 that correspond to information entered by a searcher. More specifically, the element-combination identifying part 25 identifies a single element and/or a combination of two or more elements accessed by the searcher. Information indicative of the single element and/or combination of two or more elements identified by the element-combination identifying part 25 is stored temporarily in the memory 122.

For instance, as described above, in the case where a searcher enters information indicative of the symptom “fever” as a query, and the name of disease “influenza” is obtained as a search result, the element-combination identifying part 25 identifies that the information entered by the searcher corresponds to the combination of “fever” and “influenza”. At this time, the searcher may be assumed to make access to the search server 100 for conducting a search to make access to the element “influenza” after the element “fever”.

### Advertising-Information Extracting Part 26

The advertising-information extracting part 26 specifies advertising information corresponding to a single element and/or a combination of two or more elements identified by the element-combination identifying part 25 by referring to the element-advertisement associated information 114, and extracts the specified advertising information from the advertising information DB 113.

For instance, in the case where the element-combination identifying part 25 identifies the combination of “fever” and “influenza”, advertising information of “XXX medicine (pharmaceutical manufacturer A)” corresponding to the combination of “fever” and “influenza” is extracted from the element-advertisement associated information 114 shown in FIG. 7. The advertising information extracted by the advertising-information extracting part 26 is stored temporarily in the memory 122.

### Data Transmitting Part 27

The data transmitting part 27 transmits search result information and advertising information stored in the memory 122 to the user terminal T1. The search result information and advertising information are stored temporarily in the memory 212 of the user terminal T1.

At this time, in the user terminal T1, a screen (search result screen) on the basis of the search result information and advertising information stored in the memory 212 is displayed on the display unit 230 under the control of the terminal control unit 210. That is, in the case where information entered by a searcher corresponds to a single element and/or a combination of two or more elements included in the element-advertisement associated information 114, a search result screen visibly presenting advertising information associated with the single element and/or combination of two or more elements is displayed on the display unit 230.

FIG. 9 is a diagram illustrating a search result screen G2, by way of example. As shown in FIG. 9, the search result screen G2 shows an indication of the name of disease (herein, influenza) N1 and advertisements CM1 and CM2. A searcher visibly recognizes the indication N1 to find out the name of disease being suspected from the symptoms he/she has entered. The search result screen G2 also shows the advertisements CM1 and CM2 in accordance with information entered by the searcher (e.g., query). Herein, when the searcher makes access to the search server 100 for conducting a search and to the element “influenza” after the element “fever”, advertising information corresponding to the combination of these elements is displayed visibly.

Further, on the search result screen G2, a left-click placing the mouse pointer MP over the “to treatment” button instructing display of treatment causes a screen indicating a treatment (treatment screen) to be displayed.

The display operation of the treatment screen is as follows: when an instruction requesting display of a treatment screen is made from the user terminal T1, the data retrieving part 24 searches in the medical information DB 111 for information indicative of a treatment (treatment information) against the disease displayed on the search result screen G2, and extracts the treatment information as search result information. At this time, the element-combination identifying part 25 re-identifies an element and/or a combination of elements to which a searcher has made access as well as the treatment information, by referring to the element-advertisement associated information 114. Then, the advertising-information extracting part 26 extracts new advertising information corresponding to the re-identified element and/or combination of elements. Further, the data transmitting part 27 transmits the search result information (herein, treatment information) and new advertising information are transmitted to the user terminal T1, where the treatment screen on the basis of the search result information and new advertising information is displayed on the display unit 230.

On the search result screen G2 (FIG. 9), a left-click placing the mouse pointer MP over a desired one of the advertisements CM1 and CM2 provides access to a Web page (detailed advertising information) showing detailed and substantial contents of advertising information. Then, the display screen (detailed advertising screen) G3 on the basis of the detailed advertising information is visibly displayed on the display unit 230.

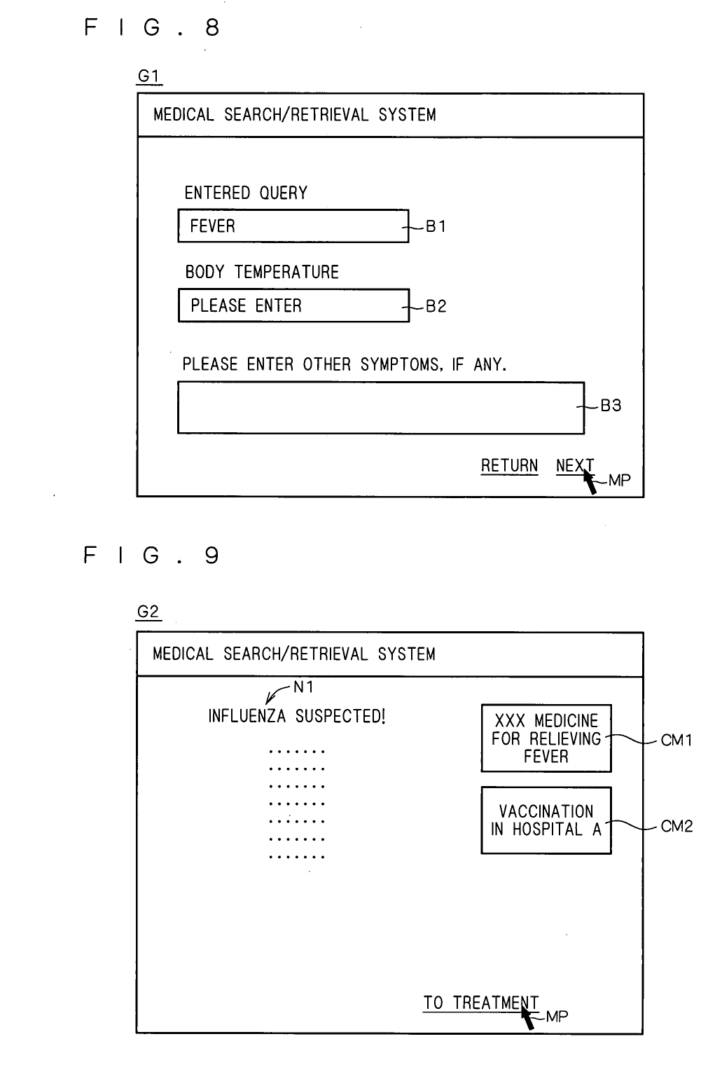

FIG. 10 is a diagram illustrating the detailed advertising screen G3, by way of example. The detailed advertising screen G3 shown in FIG. 10 illustrates a screen in which detailed advertising information about the advertisement CM1 on the search result screen G2 shown in FIG. 9 is visibly displayed. The detailed advertising screen G3 (FIG. 10) presents information such as symptoms, efficacy, usage, target age, quantity, component, etc. relating to “XXX medicine” as detailed and substantial contents of advertising information. A searcher can purchase an advertised product over the Internet by a left-click placing the mouse pointer MP over any one of order buttons D1 to D3 on the detailed advertising screen G3. Order of the product is thereby completed.

### Access-Condition Identifying Part 28

The access-condition identifying part 28 identifies access conditions of a searcher who has made access to advertising information visibly presented on the display unit 230.

The access conditions include the conditions in which: i) a searcher visibly recognizes advertisements (advertising information is just visibly presented on the display unit 230); ii) a searcher visibly recognizes the detailed and substantial contents of an advertisement (the detailed advertising screen is displayed on the display unit 230); and iii) an order induced by advertising presentation is completed; and the like.

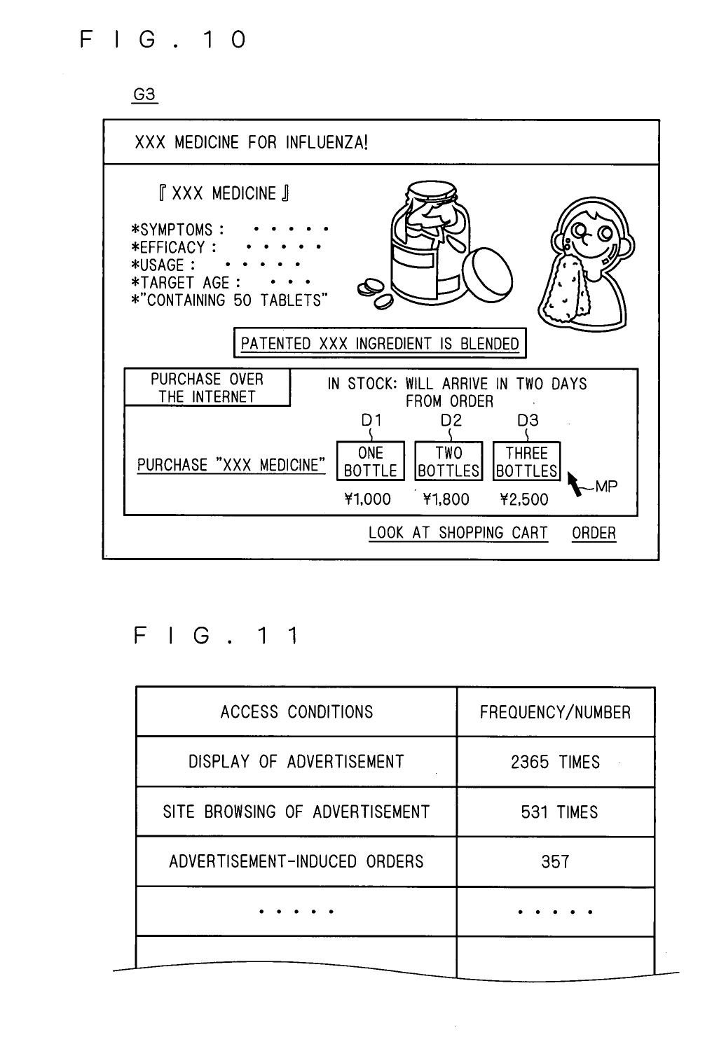

FIG. 11 is a diagram illustrating the contents of advertisement access control table A1, which manages the access conditions of searchers who have made access to advertising information identified by the access-condition identifying part 28. More specifically, the advertisement access control table A1 manages the frequency with which an advertisement is displayed (advertisement displayed frequency), the frequency with which a site containing detailed information on the advertisement (detailed advertising information) is browsed (site browsed frequency) and the number of orders induced by the advertisement (advertisement-induced order number).

For instance, when a certain advertisement is displayed on the search result screen G2 as shown in FIG. 9, the access-condition identifying part 28 increments the advertisement displayed frequency of the displayed advertisement by one. When the detailed advertising screen G3 is displayed as shown in FIG. 10, the site browsed frequency is incremented by one. Further, when an order is completed on the detailed advertising screen G3 as shown in FIG. 10, the advertisement-induced order number is incremented by one.

### Advertising-Fee Calculating Part 29

The advertising-fee calculating part 29 calculates information (charging information) indicative of an advertising fee to be charged to an advertiser of advertising information, in accordance with the access conditions of searchers who have made access to the advertising information managed by the advertisement access control table A1. The charging information is calculated on the basis of the fee calculating rule information CR stored in the storage unit 110. For instance, defining the advertisement displayed frequency as CN, the site browsed frequency as SN, the advertisement-induced order number as TN, a fee for one advertisement display as a first fee M1, a fee for one site browsing as a second fee M2 and a fee for one order completed as a third fee M3, then, an advertising fee MQ for a piece of advertising information is expressed by the following equation (1):

MQ=(CN×M1)+(SN×M2)+(TN×M3) (1)

As described, the advertising-fee calculating part 29 calculates the advertising fee MQ to be charged to an advertiser of advertising information in accordance with the frequency of presentation of the advertising information, the frequency of access by searchers to detailed and substantial contents information of the presented advertising information, and the number of orders induced by the presented advertising information.

FIG. 12 is a diagram illustrating the contents of charging list information L1 for managing the advertising fee MQ obtained by the above equation (1) for each piece of advertising information.

It is noted that advertising fees may automatically be collected from advertisers using electronic money or the like on the basis of the charging list information L1 thus obtained and managed, or an administrator may check the charging list information L1 from the management terminal 200 to thereby bill advertisers for advertising fees.

### Reward-Information Determining Part 30

The reward-information determining part 30 determines information (reward information) for giving a predetermined reward to an information provider who provides at least part of the plurality of pieces of information constituting the medical information DB 111. The reward information determined by the reward-information determining part 30 is managed for each information provider in the reward list information L2 stored in the storage unit 110.

For instance, when an information provider provides new information to constitute the medical information DB 111 from the user terminal T2, a reward may be determined in accordance with the number of decomposed elements (decomposed element number) obtained by the data construction part 22 by decomposing the new information (newly provided information). A predetermined reward is first considered as a monetary reward, and such monetary reward may be calculated by, for example, multiplying the decomposed element number of the newly provided information by a predetermined amount. The predetermined reward may further include a point, goods, a title of highly-contributed information provider, and the like.

### Calculating-Rule Changing Part 31

When an information provider is also an advertiser of advertising information, the calculating-rule changing part 31 changes the calculating rule of charging information to be charged to the advertiser which is calculated by the advertising-fee calculating part 29, such that an advertising fee charged to such advertiser is cheaper than ordinary advertisers.

For instance, assuming that a point is given for newly provided information and is managed by the reward list information L2, the calculating-rule changing part 31 may change the first to third fees M1 to M3 stepwise in accordance with the number of points by referring to the reward list information L2. To allow such change to be made, a plurality of levels of first to third fees M1 to M3 that correspond to a plurality of levels of points may previously be determined in the fee calculating rule information CR.

### Operational Flow of Search-Related Operations

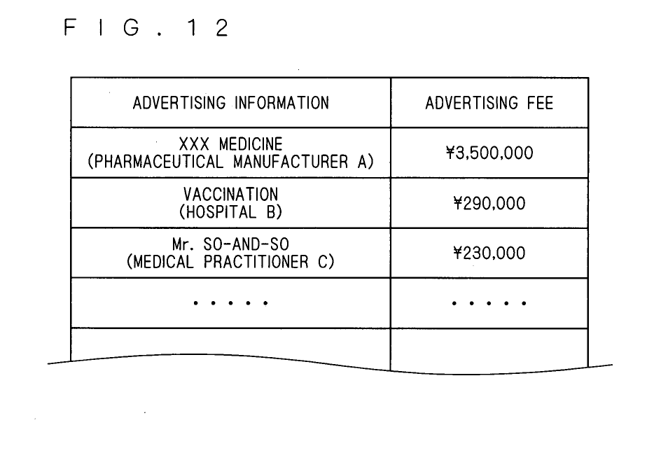

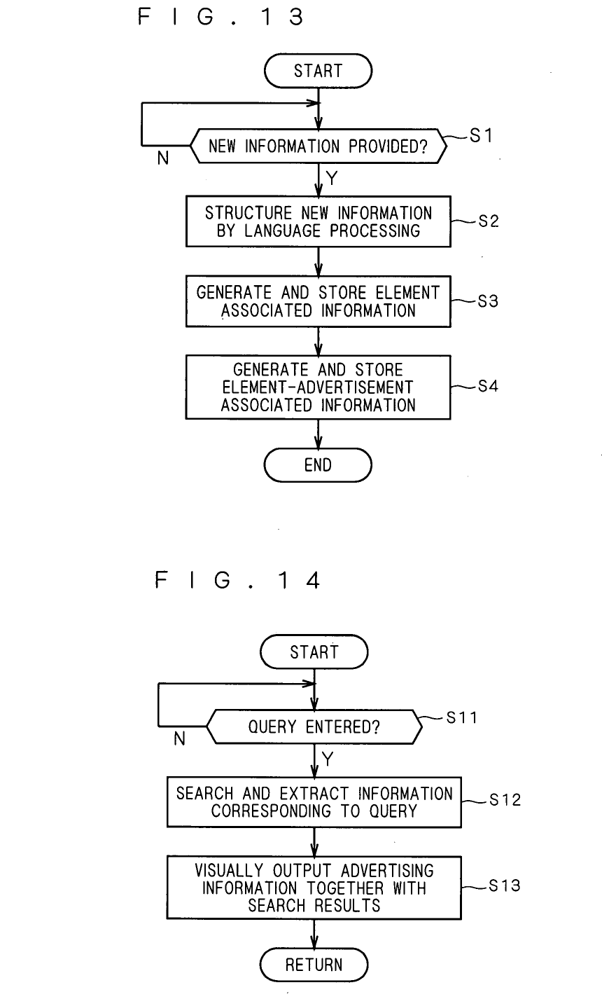

FIGS. 13 and 14 are diagrams each showing an operational flow in the DB system 1. More specifically, FIG. 13 shows an operational flow of search information structuring operation, and FIG. 14 shows an operational flow of medical information search operation. The operational flows shown in FIGS. 13 and 14 are executed by the respective functions of the control unit 120, terminal control units 210, 310, 410, and the like in cooperation with each other, and are started by an administrator by operating the operation unit 440 of the management terminal 200 as appropriate.

The search information structuring operation shown in FIG. 13 will be described now.

In step S1, the control unit 120 judges whether or not new information has been provided by an information provider. Herein, the judgment in step S1 is repeated until new information is provided, and the process proceeds into step S2 when new information is provided.

In step S2, the data construction part 22 structures the provided new information by language processing. For instance, when a plurality of findings are provided as new information, each finding is structured in the form as shown in FIG. 5.

In step S3, the data construction part 22 generates the element associated information 112 on the basis of the structured data generated in step S2, and stores it in the storage unit 110. Herein, the element associated information 112 is newly generated, if not yet generated. When the element associated information 112 has already been generated, elements relating to the new information is added to update the element associated information 112.

In step S4, the element-advertisement associating part 23 generates the element-advertisement associated information 114, and stores it in the storage unit 110. Herein, when an administrator operates the operation unit 440 of the management terminal 200 as appropriate upon request from an advertiser, the element-advertisement associated information 114 (e.g., FIG. 7) in which advertising information is associated with a single element and/or a combination of two or more elements included in the element associated information 112 generated in step S3 is generated. Herein, the element-advertisement associated information 114 is newly generated, if not yet generated. When the element-advertisement associated information 114 has already been generated, new information is added to update the element-advertisement associated information 114.

The medical information search operation shown in FIG. 14 will now be described.

In step S11, the control unit 120 judges whether or not a query has been entered from the user terminal T1, T2 or T3. Herein, the judgment in step S11 is repeated until a query is entered, and the process proceeds into step S12 when a query is entered. A query is entered by a searcher on the initial search screen G1 shown in FIG. 8, for example.

In step S12, information corresponding to the entered query is searched and extracted. Herein, the data retrieving part 24 searches and extracts the search result information corresponding to the entered query, and stores it temporarily in the memory 122. At this time, the element-combination identifying part 25 identifies a single element and/or a combination of two or more elements included in the element associated information 112 that correspond to the query entered by the searcher. Then, the advertising-information extracting part 26 specifies advertising information corresponding to the identified single element and/or combination of two or more elements, by referring to the element-advertisement associated information 114, and extracts the specified advertising information from the advertising information DB 113, and stores it temporarily in the memory 122. Further, the data transmitting part 27 transmits the search result information and advertising information stored in the memory 122 to the user terminal from which the query has been entered, and are stored in the memory of the user terminal.

In step S13, in the user terminal from which the query has been entered, the advertising information is visibly output on the display unit under the control of the terminal control unit along with the search result information searched and extracted in step S12. For instance, the search result screen as shown in FIG. 9 is displayed.

Some specific examples of advertising information visibly displayed along with the search result information on the basis of the element-advertisement associated information 114 shown in FIG. 7 will now be described. First, it is assumed that a searcher makes access to the search server 100 from the user terminal T1, T2 or T3 for conducting a search, and makes access to the element “influenza” after the element “fever”. Then, the advertisement of “XXX medicine (pharmaceutical manufacturer A)” is displayed. The advertisement of “vaccination (hospital B)” is also displayed when the searcher makes access to the element “influenza”. At this time, the search result screen as shown in FIG. 9 is displayed. When the searcher makes access to the element “influenza” after the element “nausea”, the advertisement of “vaccination (hospital B)” alone is displayed. When the searcher makes access to the “appendicitis” after the element “fever”, no advertisement is displayed. When the searcher makes access to the element “nutrition” after the element “medicine 2”, the advertisement of “Mr. so-and-so (medical practitioner C)” is displayed.

In this manner, registration of advertising information to every detail is made possible by, for example, using the element associated information 112 in which elements are structured and associated to each other. Further, since advertising information can be registered in association with each combination of elements, different advertisements can be registered for the elements “influenza” and “appendicitis” associated with the same symptom “fever”. Similarly, different advertising information can be registered for the elements “fever” and “nausea” for the same name of disease “influenza”.

As described, in the DB system 1 according to the preferred embodiment of the present invention, advertising information is associated with each combination of elements included in a plurality of pieces of information constituting the medical information DB 111, and is registered in the form of element-advertisement associated information 114. When information entered by a user corresponds to a combination of elements as registered, registered advertising information is visibly presented to the user. The employment of such structure achieves presentation of appropriate advertisements in accordance with user's conditions; and moreover, achieves presentation of advertisements to every detail in accordance with user's conditions.

Further, charging information to be charged to an advertiser of the presented advertising information is calculated in accordance with the access conditions of searchers who have made access to that advertising information. More specifically, charging information to be charged to the advertiser of advertising information is calculated in accordance with the frequency of presentation of the advertising information, the frequency of access by users to detailed and substantial contents of the presented advertising information and the number of orders induced by the presented advertising information. Employing such structure, each advertiser just has to pay an advertising fee in accordance with advertisements actually presented, advertising effectiveness and sales, which provides transparency in the advertising fee.

Furthermore, the employment of the structure in which information providers who provide information constituting the medical information DB 111 are given rewards promotes an expansion of variety of information constituting the medical information DB 111.

Still further, the employment of the structure of reducing the advertising fee charged to an advertiser who is also an information provider of information constituting the medical information DB 111 promotes an expansion of variety of information constituting the medical information DB 111.

Information in which a plurality of elements included in information constituting the medical information DB 111 are associated with each other is described in RDF, which facilitates description of information in which the plurality of elements are associated with each other.

Further, the element associated information 112 in which a plurality of elements included in information constituting the medical information DB 111 are structured and associated with each other is generated by using language processing, which allows information in which the plurality of elements are associated with each other to be generated easily and appropriately.

### Variation

While the preferred embodiment of the present invention has been described above, the present invention is not limited to the above description.

For instance, in the above preferred embodiment, advertising information is visibly presented along with search result information, however, this is only an illustrative example. For instance, an e-mail system may be employed as a method of presenting advertising information. In this case, however, users of the DB system 1 are required to make user registration and enter their e-mail addresses.

An e-mail containing advertising information may be transmitted at any time, and an e-mail magazine may be employed, for example. More specifically, an e-mail containing advertising information of vaccination for influenza may be sent to searchers who made access to the element of name of disease “influenza” last year. With such structure, advertisements that a user needs is sent by e-mail. Similarly to the above preferred embodiment, the employment of such structure also achieves presentation of appropriate advertisements in accordance with user's conditions; and moreover, achieves presentation of advertisements to every detail in accordance with user's conditions.

In the above preferred embodiment, the advertising fee is calculated in accordance with the access conditions of searchers who have made access to advertising information, however, this is only an illustrative example. Charging information may be obtained by counting histories, such as, to which element searchers have made access, to which combination of elements searchers have made access, which keyword is contained in search result information, and the like, to indirectly identify the access conditions of searchers who have made access to the advertising information.

Alternatively, the advertising fee may be calculated when registering advertising information on the basis of previously counted histories, such as, how many times and to which element in the element associated information 112 users have made access, and how many times and to which combination of elements users have made access. For instance, the advertising fee may be set higher for elements or combinations of elements that are accessed frequently.

In the above preferred embodiment, elements constituting the element associated information 112 are extracted from findings stored in medical information DB 111, however, this is only an illustrative example. For instance, elements constituting the element associated information 112 may be extracted from medical books, textbooks and sentences, for example.

According to the above preferred embodiment, users (searchers) of the DB system 1 are not charged, however, this is only an illustrative example. The DB system 1 may employ a membership system with charge.

In such case, the data center 2 may promote an expansion of variety of contents of information stored in the DB system 1 by utilizing its funds. Further, in this case, the DB system 1 may be used at no charge or low charges as an incentive for an information provider.

Such membership system allows meticulous attention to be given to each user to more details. For instance, a system in which membership registration requires entering one's e-mail address easily achieves the aforementioned service using e-mail.

While the above preferred embodiment has listed the element classified items of “symptom”, “name of disease”, “medicine” and “treatment”, this is only an illustrative example. Items such as “period”, “date” and the like may be included. For instance, an advertisement of “influenza” may be set to be presented during winter. In other words, seasonally narrowed advertisements may be presented. Further, element classified items may also include various other items such as “old or young, male or female”, “presence or absence of allergy”, “preexisting condition”, “whether or not pregnant”, and the like. Defining element classified items according to necessity allows advertising information to be provided to more details in accordance with user's conditions.

While elements constituting the element associated information 112 are words in the above preferred embodiment, this is only an illustrative example. For instance, the elements may be phrases or sentences, and further, may be visuals and the like. Specific examples of such visuals include “an image of a mask”, “a chart indicating intakes of respective nutrients” and the like, as elements belonging to the item “treatment”, for example.

While the above preferred embodiment has described charging in accordance with the number of orders completed, different advertising information may be presented in accordance with the number of orders completed. For instance, the contents of advertising information distributed by an e-mail magazine may be changed according to the number of orders completed. That is, the contents of information to be advertised may be changed in accordance with the access conditions of the past by each user who has made access to the advertising information.

While the medical information DB 111 has been described by way of example in the above preferred embodiment, this is only an illustrative example as a database storing a plurality of types of information. For instance, a plurality of types of information stored in a database may contain information belonging to at least one or more categories of medical care, nursing and caregiving, or other types of information. In the case where a plurality of types of information stored in the database contains information belonging to at least one or more categories of medical care, nursing and caregiving, advertisers of advertising information may include at least one or more entities of hospital, medical practitioner, clinic, medical equipment manufacturer, school for medical care, publisher for medical care and pharmaceutical manufacturer. Such structure allows appropriate advertisements in accordance with information constituting the database to be presented to users.

The method of presenting advertising information described in the above preferred embodiment may be applied to a database system for providing other various types of information.

(1) For instance, such database system may be an e-learning system for providing an educational material suitable for a user from a database storing a great deal of information relating to education.

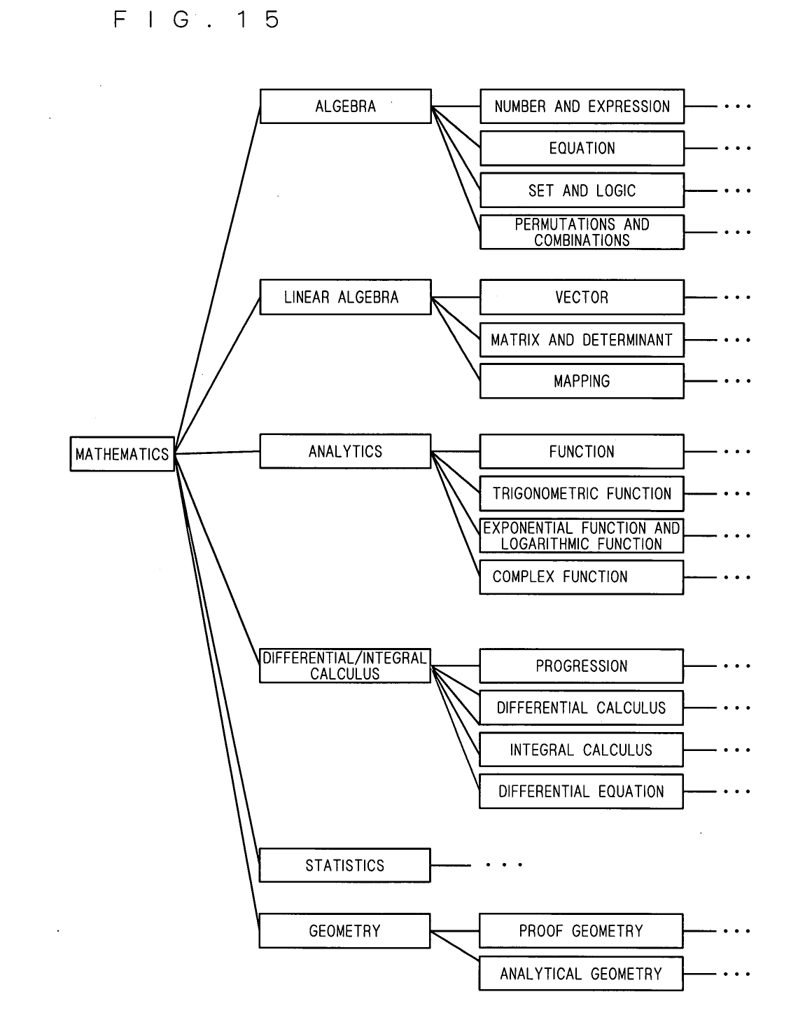

FIG. 15 is a diagram illustrating element associated information in the e-learning system, and FIG. 16 is a diagram illustrating element-advertisement associated information in the e-learning system. Herein, an e-learning system for learning mathematics is illustrated by way of example.

For instance, when a user makes access to the element “differential equation” after the element “differential/integral calculus”, advertising information of a study guide A (publisher X) is visibly presented to the user. When a user makes accesses to the element “vector” after the element “linear algebra”, advertising information of a workbook B (publisher Y) is visibly presented to the user. When a user makes accesses to the element “trigonometric function” after the element “analytics”, advertising information of a solution book C (publisher Z) is visibly presented to the user.

Such e-learning system may provide various details of learning. In the case of a learning material for nurse, for example, advertising information relating to nursing or caregiving, such as “wheel chair”, may be visibly presented according to necessity.

The employment of such structure allows appropriate advertisements in accordance with the details that a user wants to learn to be visibly presented to the user. That is, advertising information is visibly presented in accordance with user's search conditions, which achieves efficient presentation of advertising information to every detail in accordance with user's conditions.

(2) Another database system may be an auction system using an auction site dealing with various goods, or the like.

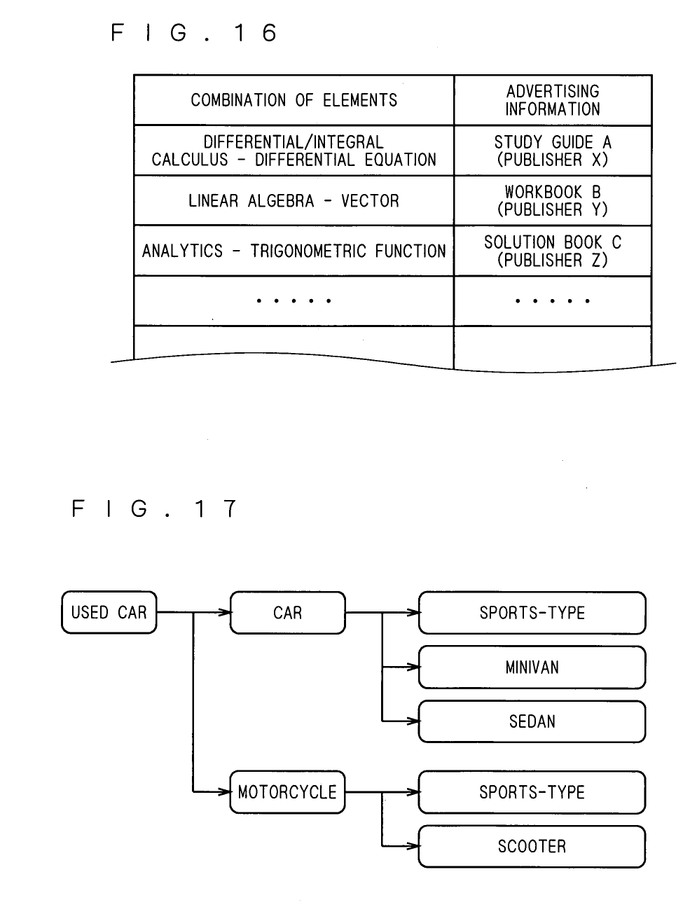

FIGS. 17 to 19 are diagrams for explaining an auction system for used cars.

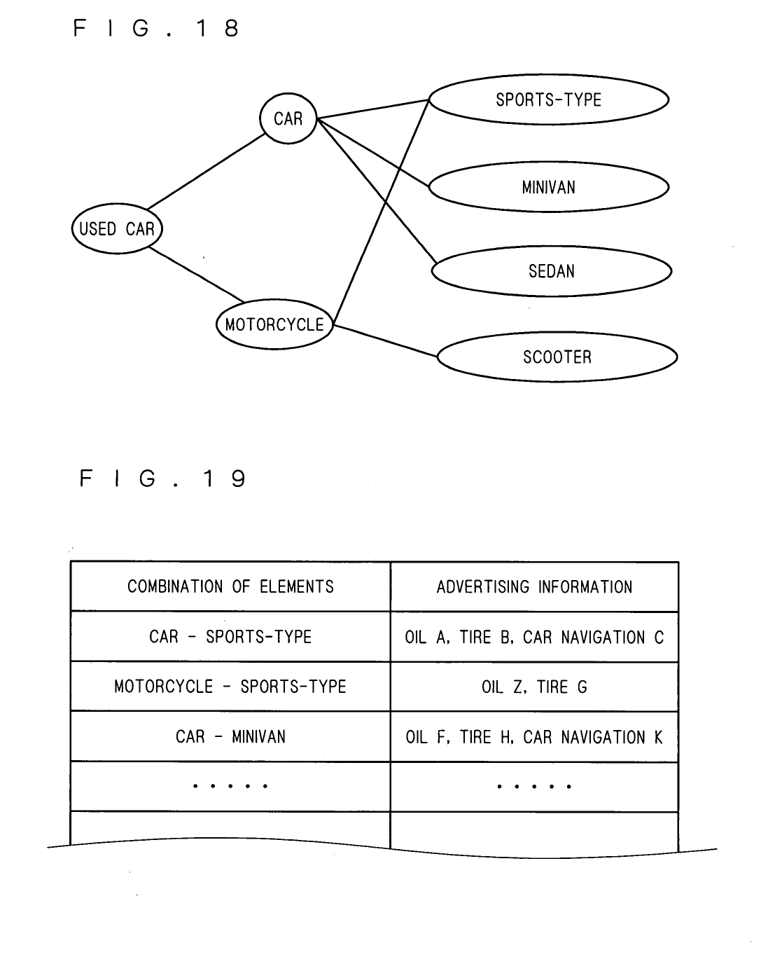

FIG. 17 illustrates the hierarchical structure of contents in the auction site. FIG. 18 illustrates element associated information in the auction system. FIG. 19 illustrates element-advertisement associated information in the auction system.

In FIG. 17, elements decrease in level from left to right. As shown in FIG. 17, the element “used car” includes the elements “car” and “motorcycle”, and the element “car” includes the elements of “sports-type”, “minivan” and “sedan”. The element “motorcycle” includes the elements of “sports-type” and “scooter”.

For instance, when a user makes accesses to the element “sports-type” after the element “car”, advertising information of oil A, tire B and car navigation system C is visibly presented to the user in accordance with the element-advertisement associated information shown in FIG. 19. When a user makes accesses to the element “sports-type” after the element “motorcycle”, advertising information of oil Z and tire G is visibly presented to the user. When a user makes accesses to the element “minivan” after the element “car”, advertising information of oil F, tire H and car navigation K is visibly presented to the user. Such structure allows appropriate advertisements in accordance with a target of auction that a user wants to be presented to the user. That is, this structure achieves efficient presentation of advertising information to every detail in accordance with user's conditions.

(3) Another database system may be a real estate search/retrieval system using a real estate search/retrieval site, or the like.

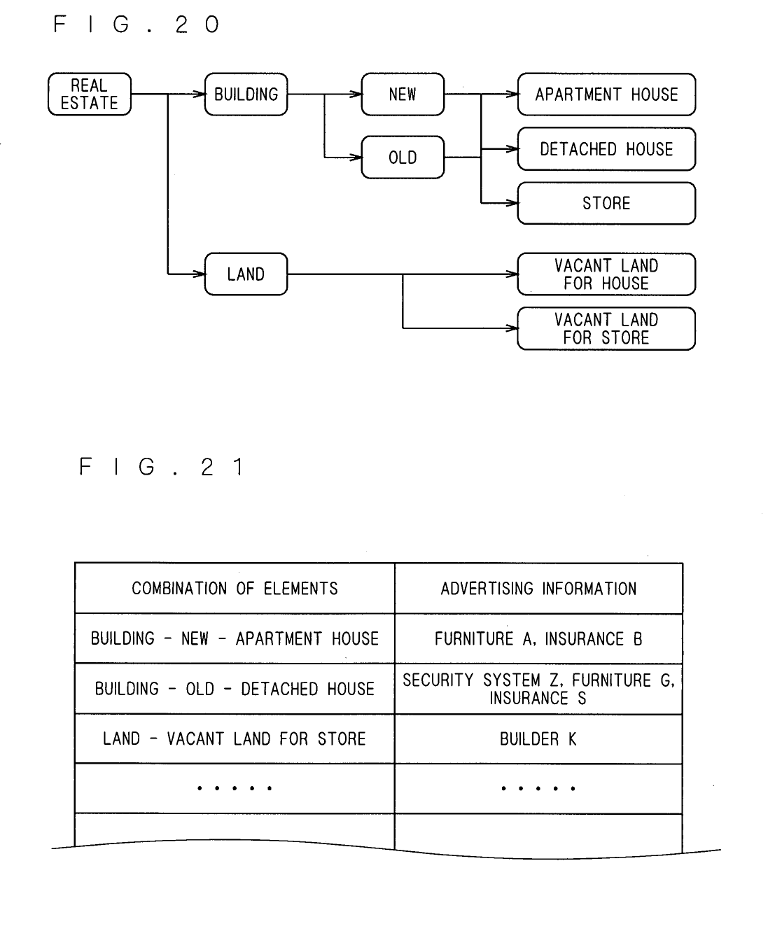

FIGS. 20 and 21 are diagrams for explaining the real estate search/retrieval system.

FIG. 20 is a diagram illustrating the hierarchical structure of contents in the real estate search/retrieval site, and FIG. 21 is a diagram illustrating element-advertisement associated information in the real estate search/retrieval system.

In FIG. 20, elements decrease in level from left to right. As shown in FIG. 20, the element “real estate” includes the elements “building” and “land”, and the element “building” includes the elements of “new” and “old”. The elements “new” and “old” respectively include the elements of “apartment house”, “detached house” and “store”. The element “land” includes the elements “vacant land for house” and “vacant land for store”.

For instance, when a user makes access to the elements “building”, “new” and “apartment house” successively in this order, advertising information of furniture A and insurance B is visibly presented to the user on the basis of the element-advertisement associated information shown in FIG. 21. When a user makes access to the elements “building”, “old” and “detached house” successively in this order, advertising information of security system Z, furniture G and insurance S is visibly presented to the user. When a user makes access to the elements “land” and “vacant land for store”, advertising information of builder K is visibly presented to the user. Such structure also achieves efficient presentation of advertising information to every detail in accordance with user's conditions.

(4) Still another database system may be a search/retrieval system for personal computer purchase using a search/retrieval site for personal computer purchase, or the like.

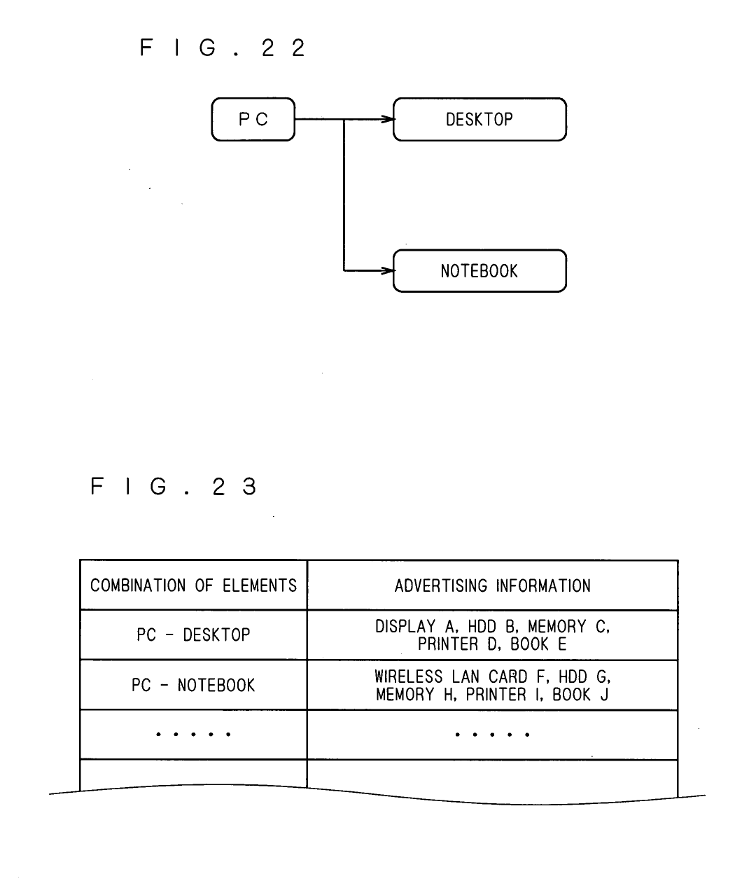

FIGS. 22 and 23 are diagrams for explaining the search/retrieval system for personal computer purchase.

FIG. 22 is a diagram illustrating the hierarchical structure of contents in the search/retrieval site for personal computer purchase, and FIG. 23 is a diagram illustrating element-advertisement associated information in the search/retrieval system for personal computer purchase.

In FIG. 22, elements decrease in level from left to right. As shown in FIG. 22, the element “personal computer (PC)” includes the elements “desktop” and “notebook”.

When a user makes access to elements “PC” and “desktop” successively in this order, advertising information of display A, HDD B, memory C, printer D and book E is visibly presented to the user on the basis of the element-advertisement associated information shown in FIG. 23. When a user makes access to the elements “PC” and “notebook” successively in this order, advertising information of wireless LAN card F, HDD G, memory H, printer I and book J is visibly presented to the user.

In this manner, advertising information is visibly presented in accordance with user's search conditions, which achieves efficient presentation of advertising information to every detail in accordance with user's conditions.

In the above preferred embodiment, the search-related operations are implemented by the cooperative operation of the plurality of terminals T1 to T3 and 200 and search server 100 over the communications circuit NT, however, this is only an illustrative example. The functions of the DB system 1 described in the above preferred embodiment may be implemented by a single device such as a single personal computer, or the like. In such case, providing a single program in a storage unit of a single device such as a single personal computer and causing a CPU to read and execute the single program achieves similar effects to those achieved by the above preferred embodiment which requires four different programs PG1 to PG4.

While the invention has been shown and described in detail, the foregoing description is in all aspects illustrative and not restrictive. It is therefore understood that numerous modifications and variations can be devised without departing from the scope of the invention.

What is claimed is:

1. A database system comprising:
a database storing a plurality of types of information;
a storage storing element associated information in which a plurality of elements included in said plurality of types of information are associated with each other and element-advertisement associated information in which advertising information is associated with a combination of two or more elements included in said plurality of elements; and
a presentation device visibly presenting said advertising information by referring to said element-advertisement associated information when information entered by a user corresponds to said combination of two or more elements.

2. The database system according to claim 1, further comprising
a calculating part calculating charging information to be charged to an advertiser of said advertising information visibly presented by said presentation device in accordance with access conditions of a user making access to said advertising information.

3. The database system according to claim 2, wherein
said calculating part calculates said charging information in accordance with a frequency of presentation of said advertising information by said presentation device.

4. The database system according to claim 2, wherein
said calculating part calculates said charging information in accordance with a frequency of user's access to detailed contents information about said advertising information visibly presented by said presentation device.

5. The database system according to claim 2, wherein
said calculating part calculates said charging information in accordance with an order quantity induced by said advertising information visibly presented by said presentation device.

6. The database system according to claim 1, further comprising
a reward-information determining part determining reward information for an information provider who provides at least part of said plurality of types of information.

7. The database system according to claim 2, further comprising
a changing part changing a calculating rule of said charging information obtained by said calculating part so as to reduce a fee charged to said advertiser of said advertising information when he/she is also an information provider of at least part of said plurality of types of information.

8. The database system according to claim 1, wherein
said element associated information is described in RDF.

9. The database system according to claim 1, further comprising
an associated information generating part structuring a plurality of elements included in said plurality of types of information and associating them with each other by using language processing, thereby generating said element associated information.

10. The database system according to claim 1, wherein
when said plurality of types of information contain information belonging to at least one or more categories of medical care, nursing and caregiving, an advertiser of said advertising information includes at least one or more entities of a hospital, a medical practitioner, a clinic, a medical equipment manufacturer, a school for medical care, a publisher relating to medical care and a pharmaceutical manufacturer.

11. The database system according to claim 1, wherein
said database system includes an auction system.

12. The database system according to claim 1, wherein
said database system includes an e-learning system.

13. A computer program controlling a computer to operate as a database system, wherein said database system comprises:
a database storing a plurality of types of information;
a storage storing element associated information in which a plurality of elements included in said plurality of types of information are associated with each other and element-advertisement associated information in which advertising information is associated with a combination of two or more elements included in said plurality of elements; and
a presentation device visibly presenting said advertising information by referring to said element-advertisement associated information when information entered by a user corresponds to said combination of two or more elements.

14. The computer program according to claim 13, wherein
said element associated information is described in RDF.

15. An advertisement presentation method in a database system, comprising the steps of:
(a) storing, in a storage, element associated information in which a plurality of elements included in a plurality of types of information constituting a database are associated with each other and element-advertisement associated information in which advertising information is associated with a combination of two or more elements included in said plurality of elements; and
(b) visibly presenting said advertising information by referring to said element-advertisement associated information when information entered by a user corresponds to said combination of two or more elements.

16. The advertisement presentation method according to claim 15, wherein
said element associated information is described in RDF.
